(19) United States
(12) Patent Application Publication
(10) Pub. No.: US 2018/0164653 A1
(43) Pub. Date: Jun. 14, 2018

(54) OBJECT WITH ADJUSTABLE APPEARANCE AND METHOD OF ADJUSTING THE APPEARANCE OF AN OBJECT

(71) Applicant: Plextek Services Limited, Saffron Walden (GB)

(72) Inventors: Aled Trefor CATHERALL, Saffron Walden (GB); Matthew Simon ROBERTS, Saffron Walden (GB)

(21) Appl. No.: 15/893,382

(22) Filed: Feb. 9, 2018

Related U.S. Application Data
(63) Continuation of application No. PCT/GB2016/052298, filed on Jul. 27, 2016.

(30) Foreign Application Priority Data
Aug. 12, 2015 (GB) 1514337.3

(51) Int. Cl. G02F 1/167; G02F 1/133; G02F 1/1335

(52) U.S. Cl. CPC G02F 1/167; G02F 1/13306; G02F 1/13336; G02F 2001/1672; G02F 1/133514

(57) ABSTRACT

An object has at least one electrophoretic display. A filter overlay covers at least a part of the electrophoretic display. Control circuitry is operable to control the electrophoretic display such that the appearance of the object viewed through the filter overlay can be adjusted.

### CROSS-REFERENCE TO RELATED APPLICATIONS

The present application is a continuation of International Patent Application No. PCT/GB2016/052298, filed on Jul. 27, 2016, which claims priority to GB Application No. 1514337.3, filed on Aug. 12, 2015 under 35 U.S.C. § 119(a). Each of the above-referenced patent applications is incorporated by reference in its entirety.

### BACKGROUND OF THE INVENTION

### Field of the Invention

The present invention relates to an object having an appearance that can be adjusted and to a method of adjusting the appearance of an object.

### Description of the Related Technology

Many items or objects, whether mobile or fixed, may have a colour scheme that is intended to match the item's surroundings (or, as an alternative, contrast with the item's surroundings). As a particular example, military vehicles are often painted with a camouflage scheme, which remains fixed for a campaign. (It will be understood that “vehicle” includes land, sea and/or airborne vehicles.) As the vehicle moves from one environment to another (e.g. from an urban to a desert or a green environment), the effectiveness of this scheme in reducing the vehicle's visual signature will vary. The chosen scheme may be highly effective in one environment, but highly ineffective in another. Similarly, a building or other fixed structure may have a camouflage scheme which is appropriate for one season of the year (for example white for winter) but which is not appropriate for other seasons (for summer say). Adaptive camouflage has been proposed previously, going back decades, but the prior proposals have a number of drawbacks.

### SUMMARY

According to a first aspect of the present invention, there is provided an object having at least one electrophoretic display, a filter overlay covering at least a part of the electrophoretic display, and control circuitry, the control circuitry being operable to control the electrophoretic display such that the appearance of the object viewed through the filter overlay can be adjusted.

In an embodiment, the filter overlay has at least one translucent coloured region.

In an embodiment, the filter overlay has plural translucent regions of different colours. In an embodiment, the electrophoretic display has plural pixels which are independently controllable such that the plural translucent regions of different colours of the filter overlay can be selectively presented.

In an embodiment, the object is a fixed structure. In another embodiment, the object is a mobile object. In an embodiment, the object is a vehicle.

According to a second aspect of the present invention, there is provided a method of adjusting the appearance of an object, the object having at least one electrophoretic display, a filter overlay covering at least a part of the electrophoretic display, and control circuitry, the method comprising:

operating the control circuitry to control the electrophoretic display such that the appearance of the object viewed through the filter overlay is adjusted.

In an embodiment, the filter overlay has plural translucent regions of different colours. In an embodiment, the electrophoretic display has plural pixels, and the method comprises independently controlling the plural pixels such that the plural translucent regions of different colours of the filter overlay can be selectively presented.

According to a third aspect of the present invention, there is provided an object having a plurality of display modules, each display module comprising at least one electrophoretic display and a filter overlay covering at least a part of the electrophoretic display, and at least one of the display modules comprising control circuitry, the control circuitry being operable to control the electrophoretic display such that the appearance of the object viewed through the filter overlay can be adjusted.

In an embodiment, at least one of the display modules has an electrical connection to at least one of the other display modules whereby signals may be passed between the connected display modules.

In an embodiment, the object comprises a central controller having an electrical connection to at least one of the display modules, whereby signals may be passed from the central controller to said at least one of the display modules. In an embodiment, the control circuitry of at least one of the display modules stores data concerning a plurality of images that can be displayed by the at least one of the display modules, the central controller being operable to command the control circuitry of the display module to display a selected one of the plurality of images.

In an embodiment, the central controller stores data concerning a plurality of images that can be displayed by at least one of the display modules, the central controller being operable to send image data to the display module to enable the display module to display a selected one of the plurality of images.

In an embodiment, at least one display module is constructed and arranged to apply a discovery protocol whereby the at least one display module identifies at least one neighbouring display module to which it is connected and passes corresponding identification information to the central controller.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows schematically an electrophoretic display;

FIG. 2 shows schematically an example of an electrophoretic display with a filter overlay and a control unit;

FIGS. 3a to 3c show schematically a filter overlay presenting different colours or different colour schemes;

FIGS. 4a to 4d show schematically a vehicle displaying different colour schemes;

FIG. 5 shows schematically an example of a display module; and

FIG. 6 shows schematically an example of interconnection of a number of display modules.

### DETAILED DESCRIPTION

Adaptive electronic camouflage has been proposed and demonstrated previously. However, previous demonstrations have involved the use of light emitting technology, such as liquid crystal displays (LCDs) and/or light projectors or the like. Such technology requires electrical power to maintain a camouflage scheme, and typically consumes relatively large amounts of electrical power. Provision of the necessary electrical power may be impractical in many cases. This is particularly the case in bright sunlight where the emitted light has to compete against reflected sunlight. Furthermore, emissive technology often generates significant amounts of heat, which results in an increase in the thermal (infra-red) signature of the object.

Embodiments of the present invention use electrophoretic technology, which is a reflective display technology rather than an emissive display technology. This presents a number of advantages. For example, typically no power is required to maintain the display of an image: power is only required to change an image, and thus the power requirements can be very low. In scenarios where the camouflage scheme is updated on an infrequent basis, the overall power consumption can be very low. Embodiments of the present invention typically produce a lower thermal signature than schemes that use emissive displays. Another advantage is that electrophoretic technology can be realised using flexible panels and flexible electronics, which can therefore be shaped or fitted around objects that are curved or have an irregular shape say. The displays can also be very thin and lightweight in comparison to other display technologies such as backlit LCD.

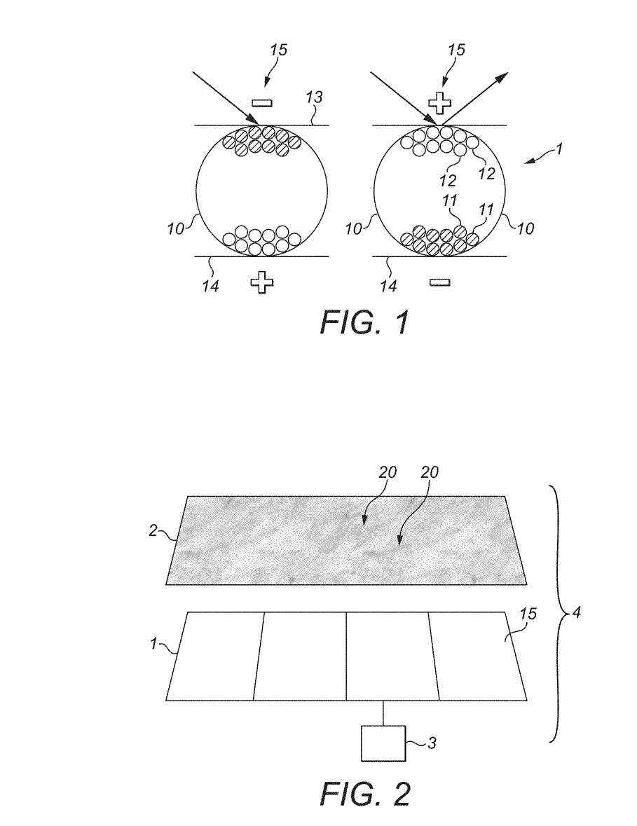

Referring to FIG. 1, as is known per se, an electrophoretic display 1 has fluid filled microcapsules 10 containing charged particles 11, 12 of different colours. The charged particles are typically black 11 and white 12. The microcapsules 10 are suspended between respective pairs of electrodes 13, 14, at least the top electrode 13 being transparent. By applying a voltage across the electrodes 13, 14, the particles 11, 12 migrate electrophoretically to the electrode 13, 14 that bears the opposite charge to that of the particle 11, 12. By altering the voltage, the fraction of particles 11, 12 of a particular colour at the upper electrode 13 can be varied from 0 through to 1. When viewed from above, this results in a microcapsule 10 having a shade of grey which can be varied from very dark (black) through to very light (white). Consequently, an electrophoretic display 1 can display greyscale images by applying the appropriate voltage across each constituent microcapsule 10. The electrophoretic display 1 is formed of repeated units of microcapsules 10 and associated electrodes 13, 14 which provide the pixels 15 of the electrophoretic display 1.

Referring to FIG. 2, in embodiments a filter overlay 2 is placed in front of the surface of an electrophoretic display 1, and may for example be placed directly onto the surface of the electrophoretic display 1. The filter overlay 2 is transparent, or at least translucent or “semi-transparent”. The filter overlay 2 may be clear (i.e. have no colour) or may have just one colour. The filter overlay 2 may have regions 20 of different colours. It will be understood that the regions 20 of different colour are indicated by different grey scales in the black-and-white drawing shown in FIG. 2. It will further be understood that the regions 20 are shown only schematically in FIG. 2 and that each will be small and discrete. The location of these regions 20 may or may not align with boundaries of pixels 15 on the electrophoretic display 1 depending on the required application. Typically, there will be plural electrophoretic displays 1 with one or more corresponding filter overlays 2. The electrophoretic displays 1 are connected (either physically or wirelessly) to control circuitry, in this example a control unit 3, which may for example be a microcontroller. The control unit 3 adjusts the greyscale image displayed by each of the electrophoretic displays 1.

In some examples, plural electrophoretic displays 1 with one or more associated filter overlays 2 are attached to the outer surface of an object such that the filter arrays 2 face outwards.

In use, when each pixel 15 of the electrophoretic display 1 is set to its lightest (white) state, the colour that is presented or is visible to an observer is determined by the regions 20 of different colour of the colour filter overlay(s) 2. By varying the shading of the individual pixels 15 on the electrophoretic display 1 through controlling the voltage applied across the respective pairs of electrodes 13, 14 using the control unit 3, a variety of different colour schemes can be generated. For example, some of the regions 20 may have different green colours. When these particular regions 20 are effectively illuminated by the corresponding pixels 15 being controlled such that the light (white) particles 12 are outermost within the microcapsules 10, the appearance will be green, with different regions having different green colours. This might be suitable where the object is in a jungle environment for example. On the other hand, some of the regions 20 may have different yellow or sand colours. When these particular regions 20 are effectively illuminated by the corresponding pixels 15, the appearance will be sandy, with different regions of yellow, which might be suitable in a desert environment for example. Regions 20 of different greys may be provided for an urban environment, and so on. Regions 20 of other colours may be provided.

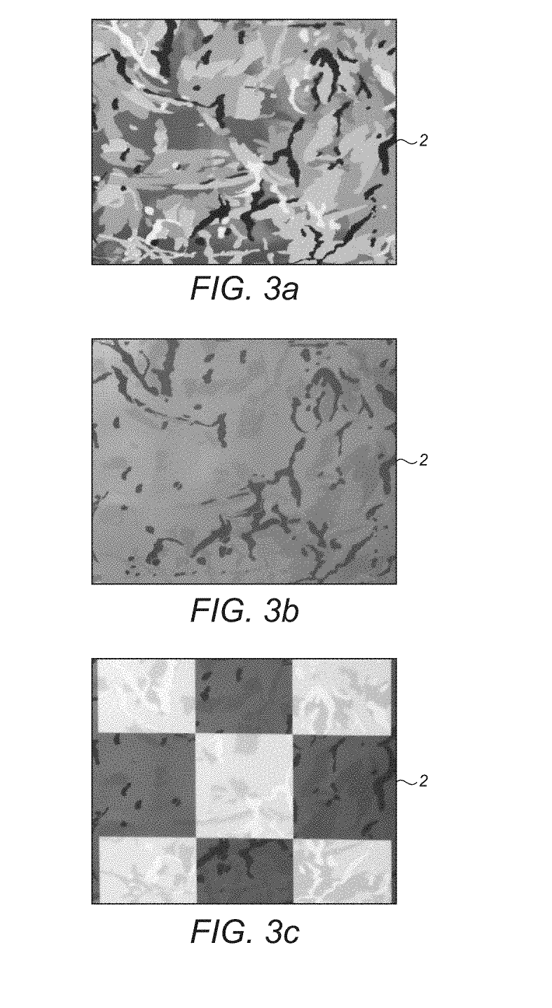

In one embodiment, the or each filter overlay 2 has many regions 20 of a wide range of colours. The control unit 3 can be controlled so that the different regions 20 may be effectively illuminated according to the environment. That is, the same filter overlay 2 can be used to provide a wide range of colour schemes, depending on which regions 20 are illuminated by control of the pixels 15 of the electrophoretic display(s) 1. This is indicated schematically in FIGS. 3a to 3c, which show one filter overlay 2 presenting different colours or different colour schemes at different times, depending on the control of the underlying pixels 15 of the electrophoretic display(s) 1.

In the above, reference is made to an observer. An observer may be a human, who may be viewing the object directly, or through for example magnifying optics, or indirectly, for example via a video feed from a remote camera which may be stationary or on board an unmanned aerial or other vehicle. An observer could also be a machine (for example, a computer or computer system) which is analysing imagery from a camera system. An observer could be viewing the object from any horizontal or vertical position.

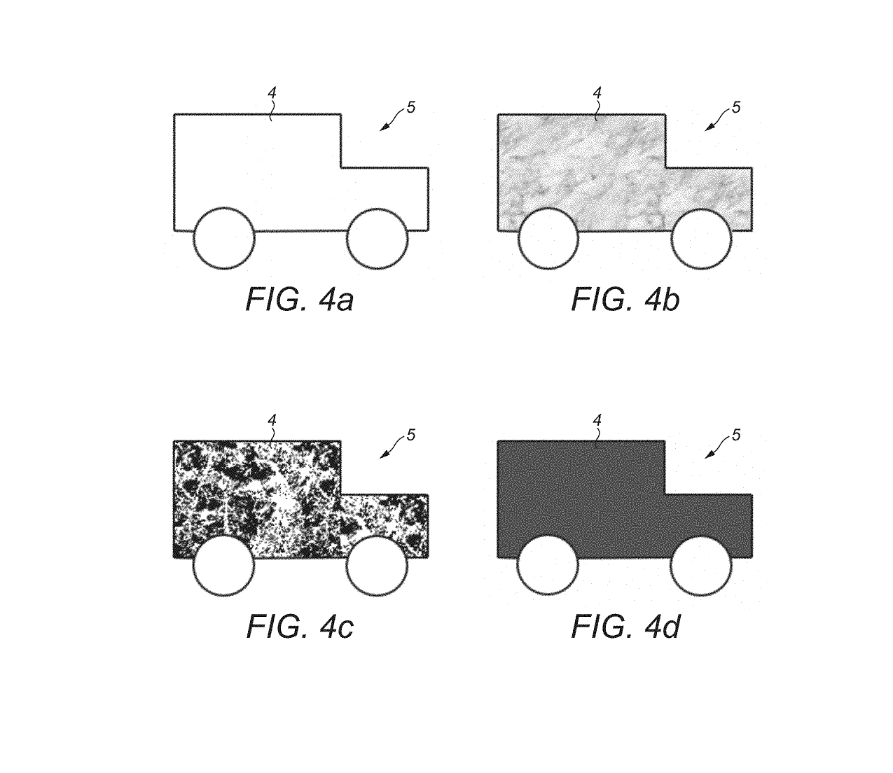

One particular application for embodiments is adaptive vehicle camouflage. Referring to FIGS. 4a to 4d, one or more camouflage modules 4, which in general each comprise one or more electrophoretic displays 1, one or more overlaid colour filter overlays 2 and a control module 3, are affixed to a vehicle 5. The one or more camouflage modules 4 may cover part or the whole or substantially the whole of the vehicle 5. The fitting of the or each camouflage module 4 may be permanent or temporary. The scheme displayed by the camouflage module(s) 4 can be adjusted via the control unit 3 to provide different display schemes, as indicated schematically by the four views shown in FIGS. 4a to 4d.

In the above embodiment, the control units 3 are each an integral part of or at least associated with a respective camouflage module 4. The individual control units 3 can be connected to, or replaced by, a central controller.

In an embodiment, the user can select from a range of camouflage schemes which are pre-loaded into the control unit 3 or the central controller, which then automatically updates each electrophoretic display 1 as needed. In for example a densely wooded area, such as a forest in a temperate climate region, the user may wish to select a dark scheme containing a disruptive pattern with no straight lines, such as that shown in FIG. 3b. In for example more sparsely woody areas, the user may wish to select a lighter version of the same scheme such as that shown in FIG. 3a. In an urban environment, a user may wish to select a scheme containing large geometric shapes, such as that shown in FIG. 3c.

In another embodiment, imagery from a camera on or next to the object could be analysed by a machine in order to automatically determine the appropriate display scheme to be used given the background environment in which the object is located at a particular time. The choice can be based by for example comparing various metrics, such as brightness and contrast of the camera imagery to each of a number of pre-loaded camouflage schemes.

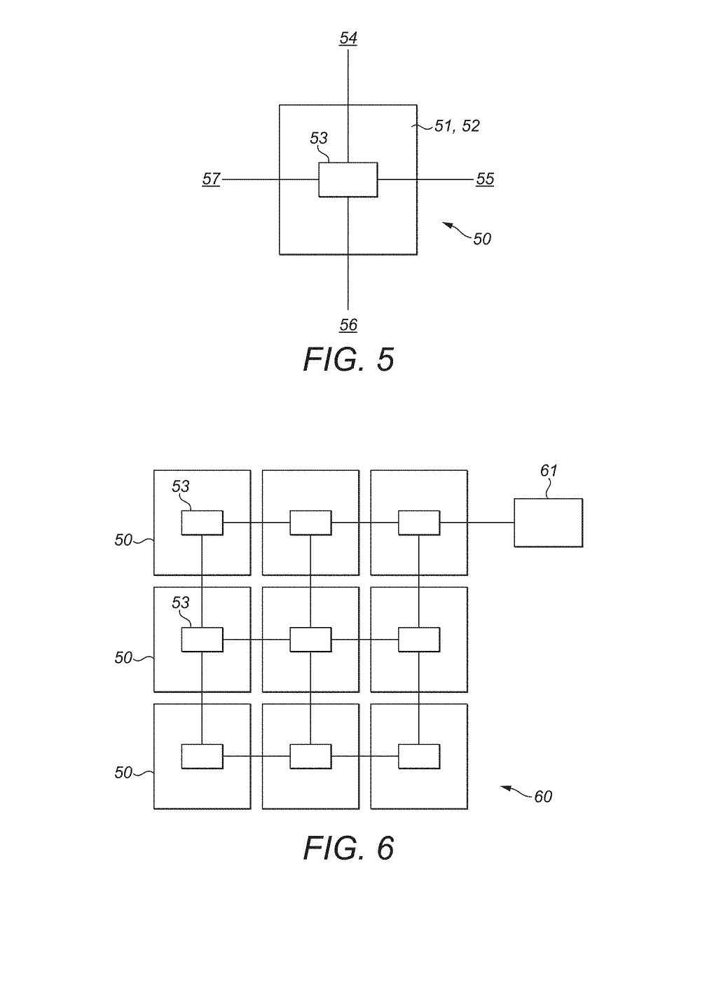

Electrophoretic displays are typically manufactured in sizes comparable to an A4 piece of paper or smaller as the primary market is e-readers and electronic food labels and the like. They are not typically manufactured in sizes sufficiently large to cover larger objects such as vehicles or other large movable objects or large fixed structures and the like. Therefore, it will often be necessary to use a number of electrophoretic displays which are connected together in an array in order to realise a display large enough for large objects. One way of achieving this will be described with reference to FIGS. 5 and 6.

Referring first to FIG. 5, in an example each display module 50 includes one or more electrophoretic displays 51 and one or more filter overlays 52. The display module 50 further includes or contains a control unit 53, which may for example be a microcontroller, and in general has four connections 54, 55, 56, 57 (referred to as North, East, South and West respectively). The connections 54, 55, 56, 57 provide for mechanical connection, or electrical connection, or both mechanical and electrical connection to adjacent display modules 50.

Referring to FIG. 6, this shows schematically the interconnection of a number of display modules 50 to form a large a large electrophoretic array 60, which, in use, will be or are fixed to a large object. The overall array 60 has a central controller 61 which has an electrical connection to at least one display module 50 and optionally to plural display modules 50. The connections between each display module 50 may use fixed mechanical connectors or detachable mechanical connectors which enable display modules 50 to be added and removed as necessary to, for example, replace any damaged display modules 50 or to realise an overall shape which conforms well to the shape of the object to which the display modules 50 are attached. The connections between the display modules 50 also allow signals to be passed between the control units 53 of the connected display modules 50. The mechanical connection and the electrical connection between connected display modules 50 may be provided by the same physical connectors or by separate physical connectors. In some examples, the electrical connections between connected display modules 50 may be a wireless connection or a wired connection or a mix of wireless and wired connections.

When a control unit 53 of a display module 50 receives a message from one or more of the control units 53 to which it is connected, it generally re-broadcasts that message on the remaining connections. In this manner, each display module 50 in the array 60 can communicate with every other display module 50 and the central controller 61 and vice-versa. An exception to this may be in the case that the receiving display module 50 is the intended recipient of a message (which may be indicated by for example the message containing the reference or identification number of the intended recipient display module 50). In this case, the receiving intended recipient display module 50 will not re-broadcast the message. A second exception may be that if the message requests that the response is along the same connection. Other exceptions may apply.

The central controller 61 controls the image shown by each of the display modules 50 in the array 60. In one embodiment, data corresponding to the images can be stored locally by each control unit 53 on each of the display modules 50. In this case, the central controller 61 simply instructs each display modules 50 which image to display from its local store. In a second embodiment, data corresponding to images are stored on the central controller 61 and raw image data is passed to a particular display module 50 in order to allow it to update its image. The second embodiment places less memory requirements on each display control unit 53 than the first embodiment, though in general this requires more data to be transmitted by the central controller 61 for each display module. 50 which may increase the time taken to update the camouflage scheme

A problem with realizing a large display array 60 from multiple smaller display modules 50 is ensuring the continuity of an image or camouflage scheme across neighbouring display modules 50. The central controller 61 preferably has knowledge of the relative location of each display module 50. This can be achieved by for example using a discovery protocol which involves each display control unit 53 first identifying its neighbouring display control units 53 (i.e. those display control units 53 to which it is directly connected) and then broadcasting that information such that the central controller 61 can receive it. This information may be or may include a reference or identification number of the corresponding display module 50 or its control unit 53. Once the central controller 61 has received the neighbour information for each display module 50 in the array 60, it can map each of the display modules 50 onto a physical location. The discovery protocol may be initiated automatically by a display module 50 when a new display module 50 is connected to it, in a “plug-and-play” like manner.

A physical location in this context may be a discrete location that can be occupied by a display module 50. A display module 50 can only be positioned in a physical location. A maximum of one display module 50 can be located at a physical location. Display modules 50 can be missing from particular physical locations. Physical locations can overlap, resulting in overlapping displays. A display module 50 that is known to be at a physical location is directly connected to one or more adjacent display modules 50 by a set of connections. For any given display module 50, a connection is defined by the display modules 50 that it connects to and the connection that is used (e.g. North, South, East, or West).

A subset of these connections can only connect a display module 50 in a known physical location to a display module 50 that is in a specific physical location. For example, in FIG. 6 the South connection of the central display module 50 can only be connected to a display module 50 in the physical location that is directly below the central physical location. These connections may be referred to as “unambiguous connections”. All of the connections in FIG. 6 are unambiguous. Connections between display modules 50 that are not perfectly aligned may be ambiguous.

The display modules 50 and their unambiguous connections can be modelled as a tree structure with the central controller 61 at its root. Each display module 50 is a node of the tree and exists only once within the tree. Each node in the tree can have up to three children (via three of the North, South, East, and West connections). The tree can then be traversed to determine the mappings of display modules 50 to physical locations.

The mapping does not require a specific tree traversal approach, but the parent of a subtree should be visited before its children (e.g. pre-order or breadth-first traversal). It is assumed that the physical location of the central controller 61 is known, that the central controller 61 has at least one unambiguous connection, that each display module 50 has at least one unambiguous connection, and that the set of all display modules 50 are connected (directly or indirectly) by unambiguous connections (i.e. the ambiguous connections are redundant). These assumptions allow a tree to be created that is built using only unambiguous connections and contains a node for each display module 50. When visiting a node, the physical location of each child display module 50 can be determined using the knowledge of the physical location of display module 50 at the current node and the set of unambiguous connections that can exist for this physical location. Once the tree traversal is complete, the physical location of each display module 50 will be known (as long as the aforementioned assumptions are true).

Examples of embodiments of the present invention provide for an adaptive camouflage concept which enables the scheme displayed to be adjusted in order for example to match the current environment. The concept is based upon covering part, or the entirety, of a vehicle or structure or platform with electrophoretic displays which have colour filter overlays. By adjusting images displayed by the displays, the apparent camouflage scheme is adjusted.

Whilst much of the above specific description concerns an adjustable or adaptive camouflage scheme, which in general is intended to reduce the object's contrast against the background environment, it will be understood that the present invention is not limited to camouflage. The present invention may be applied to any object for which is it desired to adjust its external appearance, perhaps to contrast with its environment (for example, to make the object stand out more from its environment, perhaps for safety reasons in the case of hazardous objects), for aesthetic purposes, etc., etc.

In general, the object may be a fixed object or structure, such as a building or the like. In other examples, the object is mobile, and may for example be a vehicle, which may be self-propelled or unpowered for example. The vehicle may be land, air or water based. Specific examples of objects include wheeled road vehicles, wheeled all-terrain vehicles, tracked vehicles, aerial platforms, surface vessels, mobile electric generators, fuel and water tankers (which may be fixed or mobile, and may be land, air or sea based) and ISO containers (i.e. so-called intermodal or shipping containers).

It will be understood that the processor or processing system or circuitry referred to herein may in practice be provided by a single chip or integrated circuit or plural chips or integrated circuits, optionally provided as a chipset, an application-specific integrated circuit (ASIC), field-programmable gate array (FPGA), digital signal processor (DSP), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. An object having at least one electrophoretic display, a filter overlay covering at least a part of the electrophoretic display, and control circuitry, the control circuitry being operable to control the electrophoretic display such that the appearance of the object viewed through the filter overlay can be adjusted.

2. The object according to claim 1, wherein the filter overlay has at least one translucent coloured region.

3. The object according to claim 1, wherein the filter overlay has plural translucent regions of different colours.

4. The object according to claim 3, wherein the electrophoretic display has plural pixels which are independently controllable such that the plural translucent regions of different colours of the filter overlay can be selectively presented.

5. The object according to claim 1, wherein the object is a fixed structure.

6. The object according to claim 1, wherein the object is a mobile object.

7. The object according to claim 1, wherein the object is a vehicle.

8. A method of adjusting the appearance of an object, the object having at least one electrophoretic display, a filter overlay covering at least a part of the electrophoretic display, and control circuitry, the method comprising:
operating the control circuitry to control the electrophoretic display such that the appearance of the object viewed through the filter overlay is adjusted.

9. The method according to claim 8, wherein the filter overlay has at least one translucent coloured region.

10. The method according to claim 8, wherein the filter overlay has plural translucent regions of different colours.

11. The method according to claim 10, wherein the electrophoretic display has plural pixels, comprising independently controlling the plural pixels such that the plural translucent regions of different colours of the filter overlay can be selectively presented.

12. The method according claim 8, wherein the object is a fixed structure.

13. The method according to claim 8, wherein the object is a mobile object.

14. The method according to claim 8, wherein the object is a vehicle.

15. An object having a plurality of display modules, each display module comprising at least one electrophoretic display and a filter overlay covering at least a part of the electrophoretic display, and at least one of the display modules comprising control circuitry, the control circuitry being operable to control the electrophoretic display such that the appearance of the object viewed through the filter overlay can be adjusted.

16. The object according to claim 15, wherein at least one of the display modules has an electrical connection to at least one of the other display modules whereby signals may be passed between the connected display modules.

17. The object according to claim 15, comprising a central controller having an electrical connection to at least one of the display modules, whereby signals may be passed from the central controller to said at least one of the display modules.

18. The object according to claim 17, wherein the control circuitry of at least one of the display modules stores data concerning a plurality of images that can be displayed by the at least one of the display modules, the central controller being operable to command the control circuitry of the display module to display a selected one of the plurality of images.

19. The object according to claim 17, wherein the central controller stores data concerning a plurality of images that can be displayed by at least one of the display modules, the central controller being operable to send image data to the display module to enable the display module to display a selected one of the plurality of images.

20. The object according to claim 17, wherein at least one display module is constructed and arranged to apply a discovery protocol whereby the at least one display module identifies at least one neighbouring display module to which it is connected and passes corresponding identification information to the central controller.
